(19) United States
(12) Patent Application Publication
(10) Pub. No.: US 2015/0133586 A1
(43) Pub. Date: May 14, 2015

(54) USE OF STYRENE BUTADIENE BLOCK CO POLYMERS HAVING REDUCED STYRENE CONTENT IN THE PREPARATION OF POLYMER MODIFIED ASPHALT BINDER

(71) Applicant: Innophos, Inc., Cranbury, NJ (US)

(72) Inventor: JEAN VALERY MARTIN, PRINCETON, NJ (US)

(73) Assignee: Innophos, Inc., Cranbury, NJ (US)

(21) Appl. No.: 14/517,690

(22) Filed: Oct. 17, 2014

Related U.S. Application Data
(60) Provisional application No. 61/892,098, filed on Oct. 17, 2013.

(51) Int. Cl. C08L 95/00; C08L 53/00

(52) U.S. Cl. CPC C08L 95/00; C08L 53/00
USPC 524/71

(57) ABSTRACT

Compositions and method for an asphalt and polymer composition including a Styrene-Butadiene block copolymer wherein the styrene content of said block copolymer does not exceed 30%.

### CROSS REFERENCE TO RELATED APPLICATIONS

This application claims priority under 35 U.S.C. 119(e) to U.S. Provisional Application No. 61/892,098 filed Oct. 17, 2013, incorporated herein in its entirety.

### FIELD OF THE INVENTION

The present invention relates to a method for preparing an asphalt and polymer composition comprising a Styrene-Butadiene block copolymer wherein the styrene content of said block copolymer does not exceed 30%.

### BACKGROUND OF THE INVENTION

It has long been recognized that the properties of conventional bitumen compositions can be modified by the addition of other substances, such as polymers. A wide variety of polymers have been used as additives in bitumen compositions. For example, copolymers derived from styrene and conjugated dienes, such as butadiene or isoprene, are particularly useful, since these copolymers have good solubility in bitumen compositions and the resulting modified-bitumen compositions have good rheological properties.

As noted, various polymers have been added to asphalts to improve physical and mechanical performance properties. Polymer-modified asphalts (PMAs) are routinely used in the road construction/maintenance and roofing industries. Conventional asphalts often do not retain sufficient elasticity in use and, also, exhibit a plasticity range that is too narrow for use in many modern applications such as road construction. It is known that the characteristics of road asphalts and the like can be greatly improved by incorporating into them an elastomeric-type polymer which may be one such as butyl, polybutadiene, polyisoprene or polyisobutene rubber, ethylene/vinyl acetate copolymer, polyacrylate, polymethacrylate, polychloroprene, polynorbornene, ethylene/propylene/diene (EPDM) terpolymer and advantageously a random or block copolymer of styrene and a conjugated diene. The modified asphalts thus obtained commonly are referred to variously as bitumen/polymer binders or asphalt/polymer mixes. Modified asphalts and asphalt emulsions typically are produced utilizing styrene/butadiene based polymers, and typically have raised softening point, increased viscoelasticity, enhanced force under strain, enhanced strain recovery, and improved low temperature strain characteristics as compared with non-modified asphalts and asphalt emulsions.

Presently, Applicants have discovered that the optimum formulation of a PMA made with Styrene Butadiene or Styrene Butadiene Rubber is achieved by carefully selecting a Styrene Butadiene or Styrene Butadiene Rubber containing 30% by weight or less of styrene.

### SUMMARY OF THE INVENTION

The present invention relates to a method for preparing an asphalt and polymer composition comprising a Styrene-Butadiene block copolymer wherein the styrene content of said block copolymer does not exceed 30% by weight comprising the steps of:
a. heating a source of neat asphalt;
b. adding an acid to said neat asphalt before or after the addition of a Styrene-Butadiene block copolymer wherein the styrene content of said block copolymer does not exceed 30% by weight;
c. mixing to form said asphalt and polymer composition; wherein further, said Styrene-Butadiene block copolymer comprises from about 1 to about 20 wt. % of said asphalt and polymer composition, and wherein the acid comprises from about 0.05 to about 2 wt. % of a total mixture of said asphalt and polymer composition.

### DETAILED DESCRIPTION OF THE INVENTION

The present invention relates to a method for preparing an asphalt and polymer composition comprising a Styrene-Butadiene block copolymer wherein the styrene content of said block copolymer does not exceed 30% by weight comprising the steps of:
a. heating a source of neat asphalt;
b. adding an acid to said neat asphalt before or after the addition of a Styrene-Butadiene block copolymer wherein the styrene content of said block copolymer does not exceed 30% by weight;
c. mixing to form said asphalt and polymer composition; wherein further, said Styrene-Butadiene block copolymer comprises from about 1 to about 20 wt. % of said asphalt and polymer composition, and wherein the acid comprises from about 0.05 to about 2 wt. % of a total mixture of said asphalt and polymer composition.

The Styrene-Butadiene block copolymer wherein the styrene content of said block copolymer does not exceed 30% by weight can be added at any time during the modified asphalt preparation process.

### THE PRACTICE OF THE PRESENT INVENTION

U.S. Pat. No. 8,198,350, U.S. Pat. No. 6,031,029, U.S. Pat. No. 6,228,909, U.S. Pat. No. 5,618,862, U.S. Pat. No. 5,880,185, U.S. Pat. No. 6,011,095, U.S. Pat. No. 7,495,045, U.S. Pat. No. 7,417,082, U.S. Pat. No. 8,211,960, U.S. Pat. No. 7,968,628, and U.S. Pat. No. 7,446,139 all disclose stepwise methods for preparing modified asphalt. The Styrene-Butadiene block copolymer wherein the styrene content of said block copolymer does not exceed 30% by weight can be added at any time during the modified asphalt preparation process.

In an embodiment of the invention, a cross-linked, polymer-modified asphalt is prepared by a method comprising the steps of: heating an asphalt; adding a crosslinking agent to the asphalt and mixing to form an asphalt-crosslinking agent mixture; and adding a crosslinkable polymer and an acid to the asphalt-crosslinking agent mixture; wherein following the addition of the crosslinking agent to the asphalt and the mixing to form an asphalt-crosslinking agent mixture, the acid is added and mixed with the asphalt-crosslinking agent mixture before the crosslinkable polymer is added and mixed with the asphalt-crosslinking agent mixture, thus forming a cross-linked, polymer-modified asphalt.

The Styrene-Butadiene block copolymer wherein the styrene content of said block copolymer does not exceed 30% by weight can be added at any time during the modified asphalt preparation process.

In an embodiment of the invention, a polymer modified asphalt is prepared according to the following process:

providing a source of a neat asphalt;

heating said neat asphalt;

providing a source of a phosphoric acid;

adding said acid to said neat asphalt, after the step of heating said neat asphalt;

mixing said neat asphalt for a period of time of from approximately 1 hour to approximately 2 hours, after the step of adding said acid;

further heating said neat asphalt to a temperature of from approximately 300.degree. F. to approximately 400.degree. F., after the step of mixing said neat asphalt;

providing a source of a polymer;

adding said polymer to said neat asphalt to form a blend, after the step of further heating said neat asphalt;

providing a source of a dilution asphalt;

adding said blend to said dilution asphalt to form a diluted product; and

mixing said diluted product.

The Styrene-Butadiene block copolymer wherein the styrene content of said block copolymer does not exceed 30% by weight can be added at any time during the modified asphalt preparation process.

In an embodiment of the invention, a composition suitable for use as a polymer modified asphalt is made by a plurality of steps, said plurality of steps comprising:

providing a source of a neat asphalt;

heating said neat asphalt;

providing a source of a phosphoric acid;

adding said acid to said neat asphalt, after the step of heating said neat asphalt;

mixing said neat asphalt for a period of time of from approximately 1 hour to approximately 2 hours, after the step of adding said acid;

further heating said neat asphalt to a temperature of from approximately 300.degree. F. to approximately 400.degree. F., after the step of mixing said neat asphalt;

providing a source of a polymer;

adding said polymer to said neat asphalt to form a blend, after the step of further heating said neat asphalt;

providing a source of a dilution asphalt;

adding said blend to said dilution asphalt to form a diluted product; and mixing said diluted product.

The Styrene-Butadiene block copolymer wherein the styrene content of said block copolymer does not exceed 30% by weight can be added at any time during the modified asphalt preparation process.

Another embodiment of the invention relates to a process for the preparation of bitumen/polymer compositions with a reinforced multigrade character, in which, while operating at temperatures of between 100.degree. C. and 230.degree. C. and with agitation for a period of at least 10 minutes, a bitumen or mixture of bitumens is brought into contact with, calculated by weight of bitumen or mixture of bitumens, 0.5% to 20% of a sulphur-crosslinkable elastomer and a sulphur-donating coupling agent in a quantity such as to provide a quantity of free sulphur representing 0.1% to 20% of the weight of the sulphur-crosslinkable elastomer in the reaction mixture formed from the bitumen or mixture of bitumens, elastomer and coupling agent ingredients, in order to produce a sulphur-crosslinked composition, wherein in the said process the reaction mixture resulting from the sulphur vulcanization, is maintained at a temperature of between 100.degree. C. and 230.degree. C. and with agitation, there is incorporated 0.005% to 5%, by weight of the bitumen or mixture of bitumens, of an inorganic adjuvant consisting of at least one compound selected from the group consisting of phosphoric acids, boric acids, sulphuric acid, the anhydrides of the said acids and chlorosulphuric acid, and the reaction mixture containing the inorganic adjuvant is maintained at the temperature of between 100.degree. C. and 230.degree. C. and with agitation for a period of at least 20 minutes.

The Styrene-Butadiene block copolymer wherein the styrene content of said block copolymer does not exceed 30% by weight can be added at any time during the modified asphalt preparation process.

Another embodiment of the invention relates to a process for the preparation of bitumen/polymer compositions with a reinforced multigrade nature, in which a bitumen or a mixture of bitumens is brought into contact, the operation being carried out at temperatures of between 100.degree. C. and 230.degree. C. and with stirring for a period of time of at least 10 minutes, with, with respect to the weight of the bitumen or mixture of bitumens, 0.5% to 20% of a sulphur-crosslinkable elastomer and a sulphur-donor coupling agent in an amount capable of providing an amount of free sulphur representing 0.1% to 20% of the weight of the sulphur-crosslinkable elastomer in the reaction mixture formed from the ingredients bitumen or mixture of bitumens, elastomer and coupling agent, in order to produce a sulphur-crosslinked composition, 0.005% to 5%, by weight of the bitumen or mixture of bitumens, of an acidic adjuvant being then incorporated in the reaction mixture resulting from the crosslinking with sulphur which is maintained at a temperature of between 100.degree. C. and 230.degree. C., accompanied by stirring and the reaction mixture containing the acidic adjuvant is maintained at a temperature of between 100.degree. C. and 230.degree. C., with stirring, for a period of time of at least 10 minutes, and wherein, in the said process, the acidic adjuvant is selected from the group consisting of polyphosphoric acids, acids of the formula R—(COO).sub.t—SO.sub.3 H, where t is 0 or 1 and R is a monovalent C.sub.1 to C.sub.12 hydrocarbyl radical, mixtures of at least one polyphosphoric acid and sulphuric acid, mixtures of at least one polyphosphoric acid and of at least one of the said acids R—(COO).sub.t—SO.sub.3 H, mixtures of sulphuric acid and of at least one of the acids R—(COO).sub.t—SO.sub.3 H, and mixtures of sulphuric acid with at least one polyphosphoric acid and at least one of the acids R—(COO).sub.t—SO.sub.3 H.

The Styrene-Butadiene block copolymer wherein the styrene content of said block copolymer does not exceed 30% by weight can be added at any time during the modified asphalt preparation process.

A further embodiment of the invention relates to a process for the preparation of bitumen/polymer compositions in which a bitumen or mixture of bitumens is brought into contact, the operation being carried out at temperatures between 100.degree. C. and 230.degree. C. and with stirring for a time of at least 10 minutes, with, with respect to the weight of the bitumen or mixture of bitumens, 0.01% to 20% of at least one olefinic polymer carrying epoxy or COOH functional groups, in order to form a so-called bitumen/polymer component reaction product, the said process comprising maintaining the bitumen/polymer component at temperatures of between 100.degree. C. and 230.degree. C. and with stirring, incorporating 0.005% to 6%, by weight of the bitumen or mixture of bitumens, of an acidic adjuvant and the reaction mixture thus formed is maintained at temperatures of between 100.degree. C. and 230.degree. C. and with stirring for a time of at least 10 minutes in order to produce the bitumen/polymer composition, the said acidic adjuvant being composed of one or more compounds selected from the group consisting of phosphoric acids, boric acids, sulphuric acid, the anhydrides of the said acids, chlorosulphuric acid, polyphosphoric acids, phosphonic acids of formula ##STR19## and acids of formula R—(COO).sub.t—SO.sub.3 H with, in the said formulae, t taking the value of zero or one and R denoting a monovalent hydrocarbon radical selected from the group consisting of C.sub.1 to C.sub.6 acyclic monovalent hydrocarbon radicals and cyclic monovalent hydrocarbon radicals containing 4 to 12 cyclic carbon atoms and optionally substituted by C.sub.1 to C.sub.16 acyclic monovalent hydrocarbon radicals. The Styrene-Butadiene block copolymer wherein the styrene content of said block copolymer does not exceed 30% by weight can be added at any time during the modified asphalt preparation process.

An embodiment of the invention relates to a method for preparing asphalt and polymer compositions comprising: heating an asphalt; adding an elastomeric polymer comprised of a vinyl aromatic/conjugated diene and mixing to form a mixture; adding polyphosphoric acid to the asphalt before or after the polymer and mixing to form another mixture; adding a crosslinker to the mixture after the addition of the acid and mixing to form polymer modified acid (PMA); and wherein the elastomeric polymer comprises from about 1 to about 20 wt. % of the PMA, and wherein the acid comprises from about 0.05 to about 2 wt. % of a total mixture of the PMA. The Styrene-Butadiene block copolymer wherein the styrene content of said block copolymer does not exceed 30% by weight can be added at any time during the modified asphalt preparation process.

An embodiment of the invention relates to a method for making a modified asphalt binder composition, comprising the steps of: a. providing neat asphalt in an appropriate vessel; b. heating the neat asphalt to a temperature of between about 120.degree. C. and about 200.degree. C.; c. adding to the neat asphalt a first modifying ingredient selected from the group consisting of crumb rubber, at least one acid, and one or more synthetic polymers; d. mixing the asphalt and the first modifying ingredient with one of a high shear mixer or a low shear mixer for a period of between about 5 minutes and about 10 hours; e. adding a second modifying ingredient selected from the group consisting of crumb rubber, at least one acid, one or more synthetic polymers, and a cross-linking agent, wherein the second modifying ingredient is a different type of modifying ingredient than the first modifying ingredient, and the second modifying ingredient may be a cross-linking agent only if the first modifying ingredient is crumb rubber; f. mixing the second modifying ingredient and the asphalt with one of a high shear mixer or a low shear mixer for a period of between about 5 minutes and about 10 hours g. adding a third modifying ingredient selected from the group consisting of crumb rubber, at least one acid one or more synthetic polymers and a cross-linking agent, wherein the third modifying ingredient is a different type of modifying ingredient than the first modifying ingredient and the second modifying ingredient, and the third modifying ingredient may be a cross-linking agent only if the first or the second modifying ingredient is crumb rubber; h. agitating the third modifying ingredient and the asphalt with one of a high shear mixer or a low shear mixer for a period of between about 5 minutes and about 48 hours; i. adding a fourth modifying ingredient selected from the group consisting of at least one acid one or more synthetic polymers and a cross-linking agent, wherein the third modifying ingredient is a different type of modifying ingredient than the first modifying ingredient, the second modifying ingredient, and the third modifying ingredient; and j. agitating the fourth modifying ingredient and the asphalt with a low shear mixer for a period of between about 5 minutes and about 48 hours.

The Styrene-Butadiene block copolymer wherein the styrene content of said block copolymer does not exceed 30% by weight can be added at any time during the modified asphalt preparation process.

A further embodiment of the invention relates to a method for producing a crumb rubber modified asphalt comprising the steps of: a) heating a pre-selected quantity of asphalt to a temperature of between about 325.degree. F. to 550.degree. F.; b) adding crumb rubber and a mineral acid to the heated asphalt with stirring; and c) blowing air through the asphalt, crumb rubber and mineral acid mixture.

The Styrene-Butadiene block copolymer wherein the styrene content of said block copolymer does not exceed 30% by weight can be added at any time during the modified asphalt preparation process.

An embodiment of the invention relates to a modified asphalt binder composition, comprising: a. about 60% by weight to about 98.9% by weight asphalt binder material; b. about 0.1% by weight to about 30% by weight crumb rubber; c. about 0.05% by weight to about 5% by weight of at least one acid selected from the group consisting of phosphoric acid, polyphosphoric acid, sulfuric acid at more than 90% wt, boric acid, adipic acid, citric acid, oxalic acid, tartaric acid, maleic acid, valeric acid, succinic acid, fumaric acid, glutamic acid, phtalic acid, acetic acid, and combinations thereof; and d. about 0.01% by weight to about 5% by weight of a cross-linking agent.

The Styrene-Butadiene block copolymer wherein the styrene content of said block copolymer does not exceed 30% by weight can be added at any time during the modified asphalt preparation process.

An embodiment of the invention relates to a method for making a modified asphalt binder composition, comprising the steps of: a. providing neat asphalt in an appropriate vessel; b. heating the neat asphalt to a temperature of between about 120.degree. C. and about 200.degree. C.; c. adding to the neat asphalt a first modifying ingredient selected from the group consisting of at least one acid, at least one synthetic polymer and crumb rubber; d. mixing the asphalt and the first modifying ingredient with one of a high shear mixer or a low shear mixer for a period of between about 5 minutes and about 10 hours e. adding to the modified asphalt binder a second modifying ingredient selected from the group consisting of at least one acid, at least one synthetic polymer and crumb rubber, wherein the second modifying ingredient is a different type of ingredient than the first modifying ingredient; f. mixing the second modifying ingredient and the modified asphalt binder in one of a high shear mixer or a low shear mixer for a period of between about 5 minutes and about 10 hours g. adding to the modified asphalt binder a third modifying ingredient selected from the group consisting of at least one acid, at least one synthetic polymer and crumb rubber, wherein the third modifying ingredient is a different type of ingredient than the first modifying ingredient and the second modifying ingredient; and h. agitating the third modifying ingredient and the modified binder material in one of a low shear mixer or a high shear mixer for a period of between about 5 minutes and about 48 hours.

The Styrene-Butadiene block copolymer wherein the styrene content of said block copolymer does not exceed 30% by weight can be added at any time during the modified asphalt preparation process.

Styrene-Butadiene block copolymers wherein the styrene content of said block copolymer does not exceed 30% include, but are not limited to, the following polymers:

| Polymer | Polystyrene content (% wt) |
|---|---|
| Kraton D1192 | 28.5 to 32.5% |
| Kraton D1116 | 21.2 to 24.2% |
| INNOVALT XL200 | Polyphosphoric acid 105% wt equivalent |

### RESULTS

| | Softening | Elastic |
|---|---|---|
| Description | Point (C.) | Recovery (%) |
| Neat Bitumen 70/100 | 51 | X |
| Neat + 1.5% SBS D1192 + 0.2% Crosslinker | 65 | 63.7 |
| X + 1% INNOVALT XL 200 | | |
| Neat + 1.5% SBS D1192 + 0.2% Crosslinker | 66 | 65.0 |
| X + 1% INNOVALT XL 200 | | |
| Neat + 2% SBS D1192 + 0.2% Crosslinker | 66 | 68.7 |
| X + 0.5% INNOVALT XL 200 | | |
| Neat + 2% SBS D1116 + 0.2% Crosslinker | 70 | 77.5 |
| X + 0.5% INNOVALT XL 200 | | |

Suitable inorganic acids for use in the methods herein include, but are not necessarily limited to, phosphoric acid, polyphosphoric acid, sulfuric acid, hydrochloric acid, nitric acid, and mixtures thereof. Herein, phosphoric acid includes polyphosphoric acid. In one non-limiting embodiment, the proportion of inorganic acid ranges from about 0.05 to about 2 wt % based on the total mixture of asphalt, acid and polymer. In another non-restrictive embodiment, the proportion of inorganic acid ranges from about 0.05 to about 1 wt % based on the total mixture.

Various other additives suitable for the purposes herein include, but are not necessarily limited to, known and future accelerators, activators, divalent metal oxides (e.g. zinc oxide) and the like. A variety of accelerators may be used in conjunction herein, including, but not limited to, dithiocarbamates and benzothiazoles. Many crosslinking agents and other additives are normally sold in powder or flake form.

The methods and compositions described will be further illustrated with respect to particular Examples that are only intended to more fully illuminate the compositions and methods and not limit them.

What is claimed is:

1. A method for preparing an asphalt and polymer composition comprising a Styrene-Butadiene block copolymer wherein the styrene content of said block copolymer does not exceed 30% comprising the steps of:
a. heating a source of neat asphalt;
b. adding an acid to said neat asphalt before or after the addition of a Styrene-Butadiene block copolymer wherein the styrene content of said block copolymer does not exceed 30%;
c. mixing to form said asphalt and polymer composition; wherein further, said Styrene-Butadiene block copolymer comprises from about 1 to about 20 wt. % of said asphalt and polymer composition, and wherein the acid comprises from about 0.05 to about 2 wt. % of a total mixture of said asphalt and polymer composition.
